(19) United States
(12) Patent Application Publication
(10) Pub. No.: US 2019/0136741 A1
(43) Pub. Date: May 9, 2019

(54) CONTROLLER AND CONTROL METHOD FOR ENGINE

(71) Applicant: TOYOTA JIDOSHA KABUSHIKI KAISHA, Toyota-shi (JP)

(72) Inventors: Takashi NAKAMURA, Toyota-shi (JP); Tomokazu AKUTSU, Nagakute-shi (JP); Noriyasu KOBASHI, Hachioji-shi (JP)

(73) Assignee: TOYOTA JIDOSHA KABUSHIKI KAISHA, Toyota-shi (JP)

(21) Appl. No.: 16/178,021

(22) Filed: Nov. 1, 2018

(30) Foreign Application Priority Data
Nov. 7, 2017 (JP) 2017-214915

(51) Int. Cl. F01P 7/04; F01N 3/10; B01D 46/00; F01N 3/035; F01N 9/00; F01P 5/02; B60K 11/08

(52) U.S. Cl. CPC F01P 7/04; F01N 3/101; B01D 46/0027; B60K 11/085; F01N 3/035; F01N 9/002; F01P 5/02; B01D 46/0063

(57) ABSTRACT

A controller for an engine includes a temperature raising control unit configured to execute a temperature raising process of raising the temperature of the exhaust gas purifying member and an ambient air amount control unit configured to control driving of the adjustment mechanism. The ambient air amount control unit starts an ambient air amount increasing process that controls the adjustment mechanism so that the amount of ambient air flowing into the engine compartment is increased when the temperature raising process is being executed from that when the temperature raising process is not being executed.

### BACKGROUND ART

The present invention relates to a controller and a control method for an engine.

An engine arranged in an engine compartment of a vehicle includes an exhaust gas purifying member in an exhaust passage. A temperature raising process for raising the temperature of the exhaust gas purifying member is executed to maintain the function of the exhaust gas purifying member. Japanese Laid-Open Patent Publication No. 2009-36183 describes an example of a filter that functions as the exhaust gas purifying member and captures particles in the exhaust gas, and the temperature raising process is carried out to burn and remove the particles captured by the filter.

The temperature of the exhaust system is high when the temperature raising process is executed. Thus, the temperature is high in the engine compartment. This may, for example, raise the temperature of various components in the engine compartment and cause thermal damage of the like.

### SUMMARY OF THE INVENTION

It is an object of the present invention to provide a controller and a control method for an engine that limits increases in the temperature of the engine compartment when the temperature raising process is executed.

To achieve the above object, a controller for an engine arranged in an engine compartment of a vehicle is provided. The engine includes an exhaust gas purifying member arranged in an exhaust passage and an adjustment mechanism configured to adjust an amount of ambient air flowing into the engine compartment. The controller includes a temperature raising control unit configured to execute a temperature raising process of raising temperature of the exhaust gas purifying member, and an ambient air amount control unit configured to control driving of the adjustment mechanism. The ambient air amount control unit starts an ambient air amount increasing process that controls the adjustment mechanism so that the amount of ambient air flowing into the engine compartment is increased when the temperature raising process is being executed from that when the temperature raising process is not being executed.

To achieve the above object, a method for controlling an engine arranged in an engine compartment of a vehicle is provided. The engine includes an exhaust gas purifying member arranged in an exhaust passage and an adjustment mechanism configured to adjust an amount of ambient air flowing into the engine compartment. The method includes executing a temperature raising process of raising temperature of the exhaust gas purifying member, controlling driving of the adjustment mechanism, and starting an ambient air amount increasing process of controlling the adjustment mechanism so that the amount of ambient air flowing into the engine compartment is increased when the temperature raising process is being executed from that when the temperature raising process is not being executed.

To achieve the above object, a controller for an engine arranged in an engine compartment of a vehicle is provided. The engine includes an exhaust gas purifying member arranged in an exhaust passage and an adjustment mechanism configured to adjust an amount of ambient air flowing into the engine compartment. The controller includes circuitry configured to execute a temperature raising process of raising temperature of the exhaust gas purifying member, control driving of the adjustment mechanism, and start an ambient air amount increasing process of controlling the adjustment mechanism so that the amount of ambient air flowing into the engine compartment is increased when the temperature raising process is being executed from that when the temperature raising process is not being executed.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic view showing an engine controller and a front part of a vehicle where the engine is mounted, according to one embodiment;

FIG. 2 is a flowchart showing the procedures of a process executed by a temperature raising control unit of the controller of FIG. 1;

FIG. 3 is a flowchart showing a processing procedure executed by an ambient air amount control unit of the controller of FIG. 1;

FIG. 4 is a timing chart showing an execution mode of an ambient air amount increasing process executed by the controller of FIG. 1;

FIG. 5 is a timing chart showing an execution mode of the ambient air amount increasing process executed by the controller of FIG. 1; and

FIG. 6 is a flowchart showing the ambient air amount increasing process according to a variation.

### DETAILED DESCRIPTION OF PREFERRED EMBODIMENTS

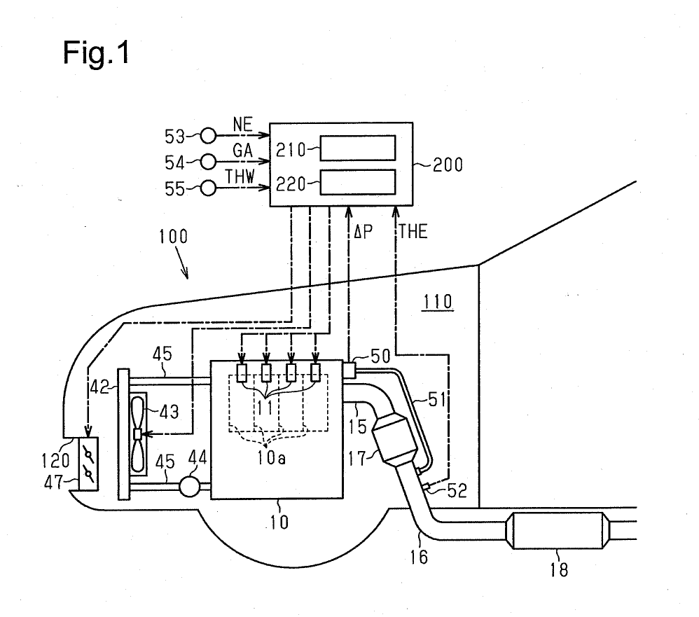

One embodiment of an engine controller will now be described with reference to FIGS. 1 to 5.

A controller 200 of the present embodiment shown in FIG. 1 controls an engine 10 mounted in an engine compartment 110 of a vehicle 100.

As shown in FIG. 1, the engine 10 includes a plurality of cylinders 10a. A fuel injection valve 11 is arranged in a combustion chamber of each cylinder 10a. In the combustion chamber of each cylinder 10a, a mixture of air, which is drawn in through an intake passage of the engine 10, and fuel, which is injected from the fuel injection valve 11, is burned when ignited by a spark discharge. The exhaust gas generated by the combustion of the air-fuel mixture in the combustion chamber is discharged to an exhaust manifold 15 that is connected to an exhaust port of the engine 10.

A three-way catalyst 17 that functions as an exhaust gas purifying member is connected to the downstream of the exhaust manifold 15. The three-way catalyst 17 oxidizes carbon hydride (HC) and carbon monoxide (CO) contained in the exhaust gas to generate coolant and carbon dioxide. Furthermore, the three-way catalyst 17 reduces nitrogen oxide (NOx) contained in the exhaust gas to generate nitrogen. The three-way catalyst 17 is arranged in the engine compartment 110.

An exhaust pipe 16 is connected to the downstream of the three-way catalyst 17. A filter 18 that functions as an exhaust gas purifying member for capturing particulate matter (PM) in the exhaust gas is arranged in the exhaust pipe 16. The filter 18 is arranged outside to the engine compartment 110. The filter 18 is arranged under the floor of the vehicle 100 in the present embodiment.

A radiator 42 that cools a coolant of the engine 10 through heat exchange with ambient air is arranged at the front part of the engine compartment 110. The radiator 42 is installed toward the rear of the vehicle from a front grille 120, which is an opening formed in a front bumper of the vehicle 100. A coolant passage 45 that circulates the coolant between the engine 10 and the radiator 42 is connected to the radiator 42, and a coolant pump 44 is arranged in the coolant passage 45.

An electric fan 43 that draws ambient air into the radiator 42 is arranged toward the rear of the vehicle from the radiator 42. The fan 43 constructs an adjustment mechanism that adjusts the amount of ambient air that flows into the engine compartment 110 by blowing air into the engine compartment 110.

A shutter (grille shutter) 47, of which the opening amount can be changed, is installed in the front grille 120. The grille shutter 47 having a variable opening amount is installed in the front grille 120. The grille shutter 47 includes a drive mechanism that is arranged toward the front of the vehicle from the fan 43 to open and close the grille shutter 47. If the grille shutter 47 is closed while the vehicle 100 is travelling, the travelling wind shielded by the grille shutter 47 is guided to the underfloor of the vehicle 100 thereby improving the flow regulating effect of the underfloor. Furthermore, when the grille shutter 47 is opened during when the vehicle 100 is travelling or when the vehicle 100 is not moving, the amount of ambient air flowing into the engine compartment 110 from the front grille 120 is increased thereby improving, for example, the cooling effect of the coolant by the radiator 42. The grille shutter 47 also constructs the adjustment mechanism that adjusts the amount of ambient air flowing into the engine compartment 110.

The controller 200 for the engine 10 includes a central processing unit (CPU), a memory, and the like, and performs various controls of the engine 10 with the CPU executing programs stored in the memory. Specifically, the controller 200 can be configured as circuitry including: 1) one or more processors running on a computer program (software); 2) one or more dedicated hardware circuitries such as a dedicated hardware (application specific integrated circuit: ASIC) and the like that executes processes of at least a portion of various processes; or 3) a combination thereof. The processor includes the CPU as well as the memory such as a RAM and a ROM, and the memory stores program codes or commands configured to cause the CPU to execute the processes. The memory, that is, a computer readable medium includes various usable media that can be accessed with a versatile or dedicated computer.

Detection signals of various types of sensors are input to the controller 200. For example, a pressure sensor 50 attached to the upper part of the engine 10 is connected with a connecting pipe 51 connecting a portion at the downstream side of the three-way catalyst 17 to the upstream side of the filter 18 in the exhaust pipe 16. The pressure sensor 50 detects a differential pressure ΔP, which is the difference between the pressure in the connecting pipe 51 and the atmospheric pressure. The differential pressure ΔP is used as a value indicating a pressure difference between an exhaust pressure at the upstream side of the filter 18 and an exhaust pressure at the downstream side of the filter 18 in the exhaust pipe 16. An exhaust gas temperature sensor 52 is arranged at a portion at the downstream side of the three-way catalyst 17 and the upstream side of the filter 18 in the exhaust pipe 16. The exhaust gas temperature sensor 52 detects an exhaust gas temperature THE, which is the temperature of the exhaust gas passing through the three-way catalyst 17. A crank angle sensor 53 arranged in the vicinity of a crankshaft of the engine 10 detects an engine rotation speed NE of the engine 10. An air flowmeter 54 arranged upstream of the intake passage of the engine 10 detects an intake air amount GA of the engine 10. A coolant temperature sensor 55 arranged in the coolant passage 45 detects a coolant temperature THW, which is a temperature of the coolant that receives heat in the engine 10.

The controller 200 controls the fuel injection with the fuel injection valve 11. Furthermore, the controller 200 includes a temperature raising control unit 210 and an ambient air amount control unit 220 serving as function units.

The temperature raising control unit 210 executes a temperature raising process for raising the temperature of the exhaust gas flowing into the filter 18 to burn and remove the PM deposited on the filter 18 and regenerate the filter 18. In the present embodiment, dither control is executed as the temperature raising process. Dither control sets some of the cylinders 10a of the engine 10 as rich combustion cylinders, of which the air fuel ratio is richer than the theoretical air fuel ratio, and sets the remaining cylinders 10a as lean combustion cylinders, of which the air fuel ratio is leaner than the theoretical air fuel ratio. When the dither control is executed, the three-way catalyst 17 accelerates reaction between the unburnt fuel component and the incomplete combustion component in the exhaust gas discharged from the rich combustion cylinders with the oxygen in the exhaust gas discharged from the lean combustion cylinder to raise the temperature of the three-way catalyst 17. When the temperature of the three-way catalyst 17 is raised, the temperature of the exhaust gas passing through the three-way catalyst 17 is raised, and the high-temperature exhaust gas flows into the filter 18 arranged at the downstream side, with respect to the exhaust gas flow, of the three-way catalyst 17 thereby raising the temperature of the filter 18. The high temperature of the filter 18 and the oxygen atmosphere of the filter 18 burns (oxidizes) and removes the PM captured by the filter 18.

The ambient air amount control unit 220 controls and drives the fan 43 and the grille shutter 47. The ambient air amount control unit 220 carries out the following control as a normal control of the fan 43. When the coolant temperature THW is higher than or equal to a predetermined driving temperature, the ambient air amount control unit 220 sets a drive duty of the fan 43 to a value slightly lower than the maximum settable value and rotates the fan 43. When the coolant temperature THW is lower than or equal to a predetermined drive stop temperature that is set to a temperature lower than the driving temperature, the ambient air amount control unit 220 sets the drive duty of the fan 43 to “0%” and stops the rotation of the fan 43.

Furthermore, the ambient air amount control unit. 220 carries out the next control as a normal control of the grille shutter 47. When the coolant temperature THW is higher than or equal to a predetermined fully opened request temperature and a cooling request degree of the coolant is high, the ambient air amount control unit 220 controls the drive mechanism of the grille shutter 47 to open the grille shutter 47. When the coolant temperature THW is lower than or equal to a predetermined fully closed request temperature that is set to a temperature lower than the fully opened request temperature, the ambient air amount control unit 220 controls the drive mechanism of the grille shutter 47 to close the grille shutter 47.

When the temperature raising process described above is being executed, the ambient air amount control unit 220 executes an ambient air amount increasing process to control and drive the fan 43 and the grille shutter 47 to increase the amount of ambient air flowing into the engine compartment 110 from the amount when the temperature raising process is not executed.

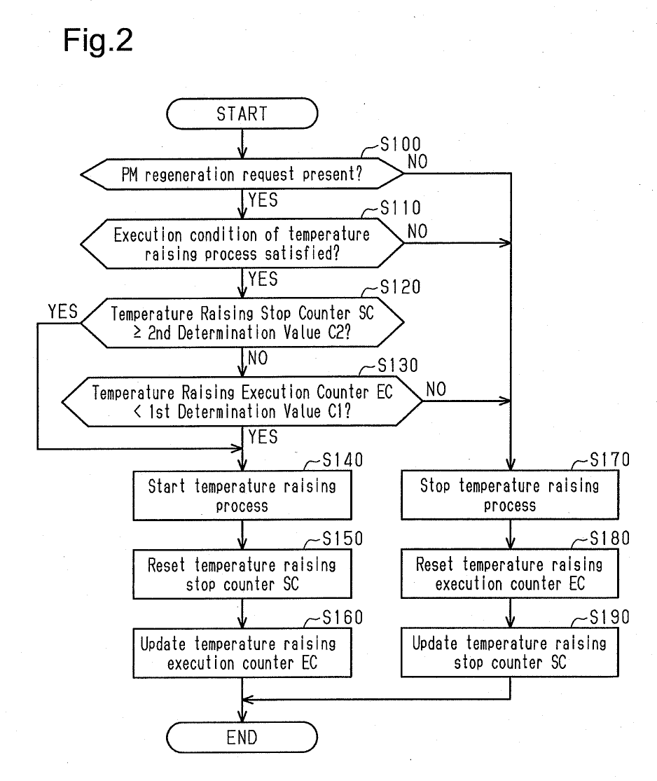

FIG. 2 shows a series of processing procedures executed by the temperature raising control unit 210. The series of processes are repeatedly executed at a predetermined control cycle by the controller 200 during the operation of the engine 10.

As shown in FIG. 2, when the series of processes are started, the temperature raising control unit 210 of the controller 200 determines whether or not there is a PM regeneration request requesting for the regeneration of the filter 18 (S100). In step S100, the presence/absence of the PM regeneration request is determined in the following manner.

The temperature raising control unit 210 calculates a PM deposition amount, which is the amount of PM sequentially deposited on the filter 18, during the engine operation in a process differing from the present process. The temperature raising control unit 210 calculates a first PM deposition amount based on the differential pressure ΔP and calculates a second PM deposition amount based on the engine operation state (i.e., fuel injection amount Q of fuel injection valve 11, intake air amount GA, and engine rotation speed NE) and selects the larger one of the first PM deposition amount and the second PM deposition amount as the final PM deposition amount. When the selected PM deposition amount is greater than or equal to a threshold value determined in advance, the temperature raising control unit 210 sets a PM regeneration request flag indicating the presence of the PM regeneration request to “ON”. The PM regeneration request flag set to “ON” indicates that the PM regeneration request is present. Furthermore, the temperature raising control unit 210 calculates a PM removal amount, which is the amount of PM being reduced from the filter 18 during the regeneration of the filter 18, based on the exhaust gas temperature THE and the like in a process differing from the present process. The temperature raising control unit 210 then calculates a PM remaining amount, which is the amount of PM remaining in the filter 18 during the regeneration of the filter 18, by subtracting the PM removal amount from the PM deposition amount when starting the regeneration of the filter 18. When the PM remaining amount is smaller than or equal to a threshold value determined in advance, the temperature raising control unit 210 sets the PM regeneration request flag to “OFF”. The PM regeneration request flag set to “OFF” indicates that the regeneration of the filter 18 has been completed and that PM regeneration request is not present or non-present.

When the PM regeneration request flag operated in such manner is set to “ON”, the temperature raising control unit 210 determines that the PM regeneration request is present in step S100 (S100: YES), and then determines whether or not an execution condition of the temperature raising process described above is satisfied (S110). In the present embodiment, the execution condition of the temperature raising process may be, for example, that the current exhaust gas temperature THE is high enough to raise the temperature of the filter 18 for the regeneration performed in the temperature raising process during the dither control and that misfiring is not occurring in each cylinder 10a.

When the execution condition of the temperature raising process is satisfied (S110: YES), the temperature raising control unit 210 determines whether or not a temperature raising stop counter SC is greater than or equal to a second determination value C2 (S120). The temperature raising stop counter SC is a counter value indicating a continuous time during which the temperature raising process has not been executed, and an initial value is set to “0”.

Furthermore, the second determination value C2 is set as a threshold value for determining whether to restart the temperature raising process after temporarily interrupting the execution of the temperature raising process and lowering the temperature of the three-way catalyst 17. When the temperature raising process is continuously executed until a temperature raising execution counter EC, which will be described later, reaches a first determination value C1, the temperature of the three-way catalyst 17 is high. The maximum value of the time required for the temperature of the three-way catalyst 17, which is high, to be lowered to a temperature allowing for determination that the temperature raising process can be restarted is obtained in advance. The value of the temperature raising stop counter SC corresponding to the maximum value is set as the second determination value C2.

When the temperature raising stop counter SC is smaller than the second determination value C2 (S120: NO), the temperature raising control unit 210 determines whether or not the temperature raising execution counter EC is smaller than the first determination value C1 (S130). The temperature raising execution counter EC is a counter value indicating a continuous execution time of the temperature raising process, and an initial value is set to “0”.

A value described next is set as the first determination value C1. When the execution of the temperature raising process is continued for a long time, the peripheral components of the three-way catalyst 17 are exposed to high temperature for a long time, which may adversely affect, for example, the lifespan of the component and the like. Therefore, a maximum value of the continuous execution time of the temperature raising process that can reduce thermal damage of the peripheral components is obtained in advance, and the value of the temperature raising execution counter EC corresponding to the maximum value is set as the first determination value C1.

When determined that the temperature raising execution counter EC is smaller than the first determination value C1 in step S130 (S130: YES) or when determined that the temperature raising stop counter SC is greater than or equal to the second determination value C2 in step S120 (S120: YES), the temperature raising control unit 210 starts the temperature raising process (S140).

When the temperature raising process is started in step S140, the temperature raising control unit 210 continues to execute the temperature raising process until the temperature raising process is stopped in step S170, which will be described later. Thus, if the temperature raising process is already started when the process of step S140 is carried out, no process is substantially carried out in the process of step S140 and the temperature raising control unit 210 continues to execute the temperature raising process.

When the temperature raising process is started in step S140, the temperature raising control unit 210 resets the temperature raising stop counter SC to “0” (S150). The temperature raising control unit 210 then adds a constant value α (e.g., “1” etc.) to the current temperature raising execution counter EC to update the temperature raising execution counter EC (S160) and then temporarily terminates the present process.

When a negative determination is made in step S100 (S100: NO), a negative determination is made in step S110 (S110: NO), or a negative determination is made in step S130 (S130: NO), the temperature raising control unit 210 stops the temperature raising process (S170). In step S170, the temperature raising control unit 210 stops the execution of the dither control and sets an air fuel ratio for all of the cylinders 10a to the theoretical air fuel ratio to stop the temperature raising process.

When the temperature raising process is stopped in step S170, the temperature raising control unit 210 continues to stop the temperature raising process until the temperature raising process is started in step S140 described above. Thus, if the temperature raising process is already stopped when the process of step S170 is carried out, no process is substantially carried out in the process of step S170 and the temperature raising control unit 210 continues to stop the temperature raising process.

When the temperature raising process is stopped in step S170, the temperature raising control unit 210 resets the temperature raising execution counter EC to “0” (S180). The temperature raising control unit 210 then adds a constant value α (e.g., “1” etc.) to the current temperature raising stop counter SC to update the temperature raising stop counter SC (S190) and temporarily terminates the present process.

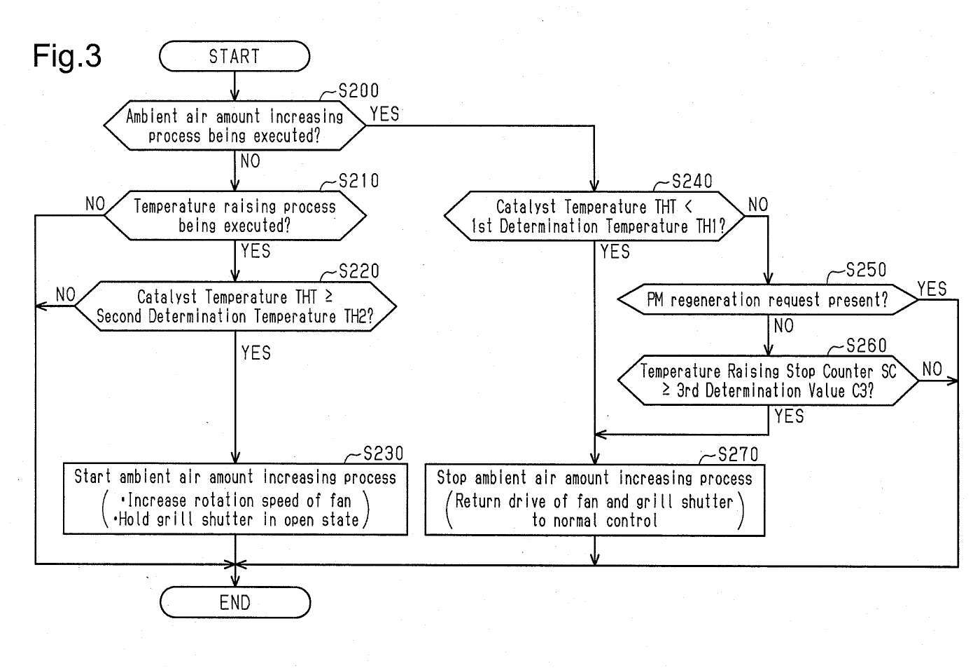

FIG. 3 shows a series of processing procedures in the ambient air amount increasing process carried out by the ambient air amount control unit 220. The series of processes are repeatedly executed at a predetermined control cycle by the controller 200 during the operation of the engine 10.

As shown in FIG. 3, when the series of processes are started, the ambient air amount control unit 220 of the controller 200 determines whether or not the ambient air amount increasing process is currently being executed (S200), and if the ambient air amount increasing process is not being executed (S200: NO), determines whether or not the temperature raising process is currently being executed (S210). When determining that the temperature raising process is not being executed (S210: NO), the ambient air amount control unit 220 temporarily terminates the present process.

When determining that the temperature raising process is being executed in step S210 (S210: YES), the ambient air amount control unit 220 acquires a current catalyst temperature THT, and determines whether or not the acquired catalyst temperature THT is higher than or equal to a second determination temperature TH2 (S220).

A value described next is set as the second determination temperature TH2. The three-way catalyst 17 has a high temperature when the temperature raising process is executed. This raises the temperature of the peripheral components arranged around the three-way catalyst 17. A temperature lower by a predetermined temperature than a specified temperature THM, which is the temperature of the three-way catalyst 17 for when the peripheral component reaches a tolerable maximum temperature, that is, an upper temperature limit, is set as the second determination temperature TH2.

When determining that the catalyst temperature THT is lower than the second determination temperature TH2 in step S220 (S220: NO), the ambient air amount control unit 220 temporarily terminates the present process.

When determining that the catalyst temperature THT is higher than or equal to the second determination temperature TH2 in step S220 (S220: YES), the ambient air amount control unit 220 starts the ambient air amount increasing process (S230), and temporarily terminates the present process.

When the ambient air amount increasing process is started, the drive duty of the fan 43 is held at a maximum value, and thus the rotation speed of the fan 43 is increased from that before the starting of the ambient air amount increasing process. Furthermore, when the ambient air amount increasing process is started, the grille shutter 47 is held in the open state. More specifically, the opening amount of the grille shutter 47 is held such that the opening amount becomes a maximum opening amount so that the grille shutter 47 is in the fully open state. Since the drive duty of the fan 43 is held at the maximum value after the grille shutter 47 is set to the fully open state, the maximum amount of ambient air is drawn into the engine compartment 110. The driving of the fan 43 and the grille shutter 47 through the ambient air amount increasing process is given priority over the normal control of the fan 43 and the grille shutter 47 described above.

When determining that the ambient air amount increasing process is being executed in step S200 (S200: YES), the ambient air amount control unit 220 acquires the current catalyst temperature THT, and determines whether or not the acquired catalyst temperature THT is lower than a first determination temperature TH1 (S240).

A temperature lower than the second determination temperature TH2 by a predetermined temperature is set in advance as the first determination temperature TH1. A specific value of the first determination temperature TH1 includes, for example, the maximum temperature of the three-way catalyst 17 in a state where the PM regeneration request is non-present and the temperature raising process is not executed during the engine operation.

When determining that the catalyst temperature THT is lower than the first determination temperature TH1 in step S240 (S240: YES), the ambient air amount control unit 220 returns to the driving of the fan 43 and the grille shutter 47 in the normal control described above, that is, stops the ambient air amount increasing process (S270), and temporarily terminates the present process.

When determining that the catalyst temperature THT is higher than or equal to the first determination temperature TH1 in step S240 (S240: NO), the ambient air amount control unit 220 determines whether or not the PM regeneration request is present (S250). When determining that the PM regeneration request is present (S250: YES), the ambient air amount control unit 220 temporarily terminates the present process.

When determining that the PM regeneration request is not present in step S250 (S250: NO), the ambient air amount control unit 220 determines whether or not the current temperature raising stop counter SC is greater than or equal to a third determination value C3 (S260).

The third determination value C3 is set as a threshold value for determining whether to terminate the ambient air amount increasing process after completing the regeneration of the filter 18 and stopping the temperature raising process. For example, a maximum value of a time required from the point of time in which the temperature raising process is stopped as the regeneration of the filter 18 is completed to the point of time at which the temperature of the three-way catalyst 17 is lower than the temperature of the three-way catalyst 17 when the temperature raising stop counter SC reaches the second determination value C2 (e.g., temperature of the three-way catalyst 17 of when the PM regeneration request is not present, and the temperature raising process is not executed, etc. while the engine operation state is in low load low rotation state) is obtained in advance. The value of the temperature raising stop counter SC corresponding to the maximum value is set as the third determination value C3.

When determining that the temperature raising stop counter SC is smaller than the third determination value C3 in step S260 (S260: NO), the ambient air amount control unit 220 temporarily terminates the present process.

When determining that the temperature raising stop counter SC is greater than or equal to the third determination value C3 in step S260 (S260: YES), the ambient air amount control unit 220 stops the ambient air amount increasing process by executing the process of step S270, and temporarily terminates the present process.

Thus, in the present embodiment, the ambient air amount increasing process is started when the following start condition A is satisfied.

Start condition A: The temperature raising process is being executed (S210: YES) and the catalyst temperature THT is higher than or equal to the second determination temperature TH2 (S220: YES).

Furthermore, the ambient air amount increasing process that has been started is stopped when the following stop condition B or stop condition C is satisfied.

Stop condition B: The ambient air amount increasing process is being executed (S200: YES) and the catalyst temperature THT is lower than the first determination temperature TH1 (S240: YES).

Stop condition C: The ambient air amount increasing process is being executed (S200: YES), the catalyst temperature THT is higher than or equal to the first determination temperature TH1 (S240: NO), the PM regeneration request is not present (S250: NO), and the temperature raising stop counter SC is greater than or equal to the third determination value C3 (S260: YES).

The operations of the present embodiment will now be described.

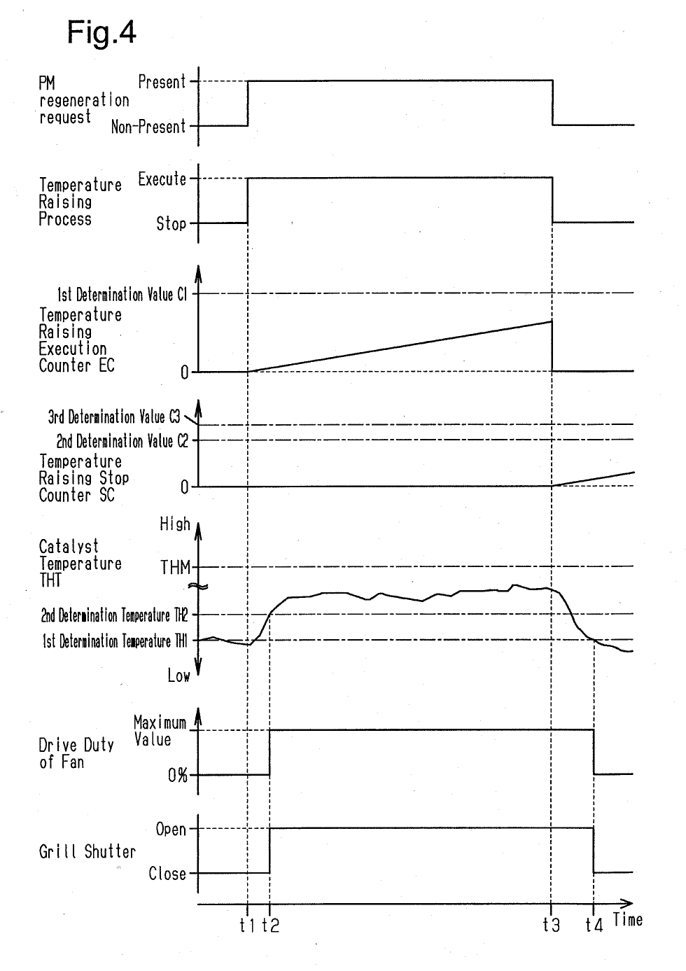

FIG. 4 shows one example of an execution mode of the ambient air amount increasing process. In FIG. 4, an example of a when the temperature raising process is terminated before the temperature raising execution counter EC reaches the first determination value C1 is shown.

First, when the PM regeneration request is changed from “non-present” to “present” at time t1, the temperature raising process is started and the three-way catalyst 17 has a high temperature. When the three-way catalyst 17 has a high temperature, the temperature in the engine compartment 110 rises and the catalyst temperature THT rises. Furthermore, when the temperature raising process is started, the temperature raising execution counter EC is gradually increased as time elapses after time t1.

When the catalyst temperature THT is higher than or equal to the second determination temperature TH2 (time t2), the ambient air amount increasing process is started. The drive duty of the fan 43 is held at the maximum value and the grille shutter 47 is held in the fully open state. When the ambient air amount increasing process is performed, a greater amount of ambient air having a temperature lower than that of the air in the engine compartment 110 is drawn into the engine compartment 110 so that the engine compartment 110 is cooled by the ambient air. This limits increases in the temperature of the three-way catalyst 17 exposed to the air in the engine compartment 110, and the catalyst temperature THT is maintained at a temperature lower than the specified temperature THM.

Thereafter, when the PM regeneration request is non-present and the temperature raising process is terminated (time t3) before the temperature raising execution counter EC reaches the first determination value C1, the temperature raising execution counter EC is reset to “0”. Furthermore, the temperature raising stop counter SC is gradually increased as time elapses after time t3. When the temperature raising process is stopped at time t3, the catalyst temperature THT decreases. When the temperature of the catalyst temperature THT is lower than the first determination temperature TH1 (time t4), the ambient air amount increasing process that has been executed is terminated.

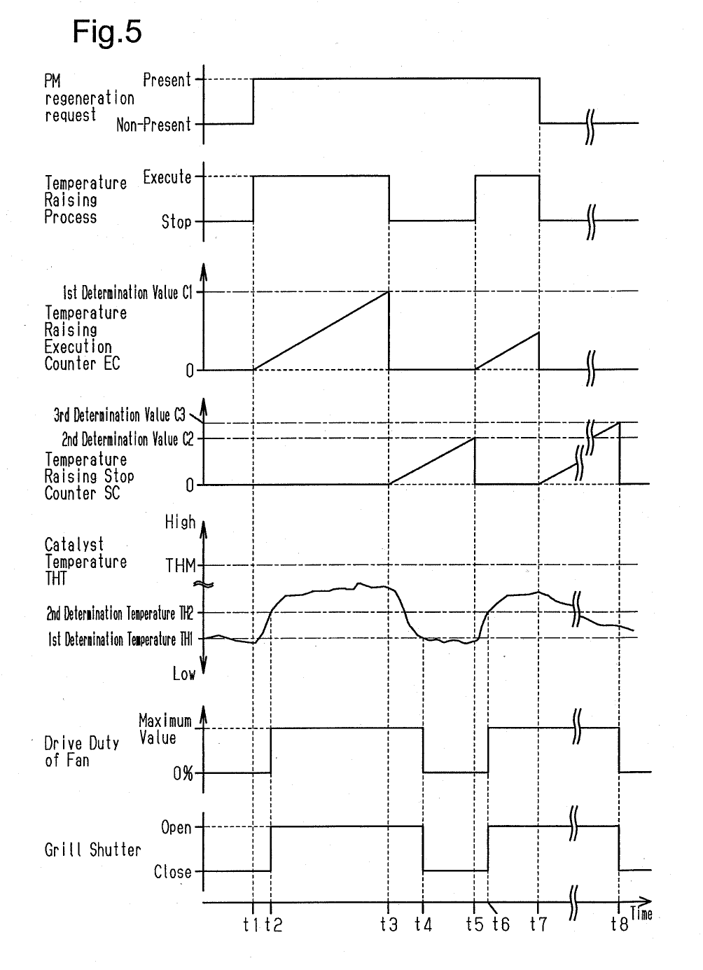

FIG. 5 shows one example of an execution mode of the ambient air amount increasing process. FIG. 5 shows an example of when the temperature raising process is temporarily terminated as the temperature raising execution counter EC reaches the first determination value C1 during the execution of the temperature raising process.

When the PM regeneration request is changed from “non-present” to “present” at time t1, the temperature raising process is started and the three-way catalyst 17 has a high temperature. When the three-way catalyst 17 has a high temperature, the temperature in the engine compartment 110 rises and the catalyst temperature THT rises. Furthermore, when the temperature raising process is started, the temperature raising execution counter EC is gradually increased as time elapses.

When the catalyst temperature THT is higher than or equal to the second determination temperature TH2 (time t2), the ambient air amount increasing process is started. The drive duty of the fan 43 is held at the maximum value and the grille shutter 47 is held in the fully open state. When the ambient air amount increasing process is performed, a greater amount of ambient air having a temperature lower than that of the air in the engine compartment 110 is drawn into the engine compartment 110 so that the engine compartment 110 is cooled by such ambient air. This limits increases in the temperature of the three-way catalyst 17 exposed to the air in the engine compartment 110, and the catalyst temperature THT is maintained at a temperature lower than the specified temperature THM.

Then, when the PM regeneration is continued for a long time and the temperature raising execution counter EC reaches the first determination value C1 (time t3), the temperature raising process is temporarily terminated. When the temperature raising process is temporarily terminated, the temperature raising execution counter EC is reset to “0” (time t3). Furthermore, the temperature raising stop counter SC is gradually increased as time elapses after time t3.

The catalyst temperature THT decreases when the temperature raising process is temporarily terminated in such manner. When the catalyst temperature THT has a temperature lower than the first determination temperature TH1 (time t4), the ambient air amount increasing process that has been executed is terminated.

Subsequently, when the temperature raising stop counter SC reaches the second determination value C2 at time t5, the temperature raising process is restarted. When the temperature raising process is restarted, the temperature raising stop counter SC is reset to “0” (time t5). Furthermore, the temperature raising execution counter EC is gradually increased as time elapses after time t5.

When the temperature raising process is resumed in such a manner, the catalyst temperature THT is raised, and the catalyst temperature THT reaches the second determination temperature TH2 (time t6). When the catalyst temperature THT reaches the second determination temperature TH2, the ambient air amount increasing process is restarted (time t6).

Thereafter, when the PM regeneration request is non-present and the temperature raising process is terminated (time t7) before the temperature raising execution counter EC reaches the first determination value C1, the temperature raising execution counter EC is reset to “0”. Furthermore, the temperature raising stop counter SC is gradually increased as time elapses after time t7. When the temperature raising process is terminated at time t7, the catalyst temperature THT subsequently decreases.

When the temperature raising stop counter SC subsequently reaches the third determination value C3 (time t8) even before the catalyst temperature. THT becomes lower than the first determination temperature TH1, the ambient air amount increasing process that has been executed is terminated. When the temperature raising stop counter SC reaches the third determination value C3, the temperature raising stop counter SC is reset to “0”.

The advantages of the present embodiment will now be described.

(1) When the start condition A is satisfied, the ambient air amount increasing process is started during the execution of the temperature raising process, and thus the amount of ambient air drawn into the engine compartment 110 is increased from that before the starting of the ambient air amount increasing process. In other words, compared to when the temperature raising process is not executed, the amount of ambient air drawn into the engine compartment 110 is increased. Specifically, the amount of ambient air that flows into the engine compartment 110 can be increased by increasing the rotation speed of the fan 43. Therefore, the cooling effect of the engine compartment 110 by the ambient air drawn into the engine compartment 110 is increased during the execution of the temperature raising process. This limits increases in the temperature of the engine compartment 110 during the execution of the temperature raising process.

(2) Since increases in the temperature of the engine compartment 110 are limited during the execution of the temperature raising process, increases in the temperatures of various components arranged in the engine compartment 110 are limited. In particular, in the present embodiment, the three-way catalyst 17 has a high temperature during the execution of the temperature raising process, and thus the peripheral components of the three-way catalyst 17 of the various components arranged in the engine compartment 110 particularly tend to have a high temperature. However, the interior of the engine compartment 110 is cooled through the execution of the ambient air amount increasing process. Thus, the temperatures of the peripheral components of the three-way catalyst 17 do not excessively rise during the execution of the temperature raising process.

(3) When executing the ambient air amount increasing process, the rotation speed of the fan 43 is increased, and the grille shutter 47 arranged in the front grille 120 is held in the fully open state in accordance with the driving of the fan 43. Therefore, the maximum amount of ambient air flows into the engine compartment 110 through the grille shutter 47, and the cooling effect of the ambient air drawn into the engine compartment 110 is increased.

(4) The temperature raising process is temporarily terminated when the temperature raising execution counter EC reaches the first determination value C1 even when the PM regeneration request is present. Thus, compared to when the temperature raising process is executed continuously while the PM regeneration request is present, the peripheral components of the three-way catalyst 17 are not exposed to high temperatures for a long time.

It should be apparent to those skilled in the art that the present invention may be embodied in many other specific forms without departing from the spirit or scope of the invention. Particularly, it should be understood that the present invention may be embodied in the following forms.

Although the dither control is carried out as the temperature raising process for raising the temperature of the three-way catalyst 17 and the filter 18, other temperature raising processes may be carried out.

Furthermore, the temperature of the exhaust gas discharged from the combustion chamber to the exhaust passage may be raised, and hence the temperature of the three-way catalyst 17 and the filter 18 may be raised by carrying out a retarding process of the ignition timing for the temperature raising process. In this case, the exhaust passage such as the exhaust manifold 15 arranged in the engine compartment 110 has a high temperature, and the temperature in the engine compartment 110 rises. In this case, however, the engine compartment 110 is cooled by carrying out the ambient air amount increasing process. This obtains the same advantages as the embodiment described.

Although the temperature raising process is executed to carry out the regeneration of the filter 18, the temperature raising process may be carried out for other reasons. For example, the temperature raising process may be carried out to recover from sulfur poisoning of the three-way catalyst 17.

The process of step S220 shown in FIG. 3 described above may be omitted, and the ambient air amount increasing process may be executed regardless of the catalyst temperature THT during the execution of the temperature raising process.

Among the stop condition B and the stop condition C, the stop condition C of the ambient air amount increasing process may be omitted. Furthermore, the stop condition B and the stop condition C of the ambient air amount increasing process may both be omitted. Following stop condition D may be set as the stop condition.

Stop condition D: The ambient air amount increasing process is being executed, the PM regeneration request is non-present, and the temperature raising stop counter SC is greater than or equal to the third determination value C3.

The processes such as the updating of the temperature raising execution counter EC (S160), the updating of the temperature raising stop counter SC (S190), the resetting of the temperature raising execution counter EC (S180), the resetting of the temperature raising stop counter SC (S150), and the like may be omitted. In other words, in the embodiment described above, the process of temporarily terminating the temperature raising process even when the PM regeneration request is present may be performed but are not essential. That is, the temperature raising process may be continuously executed while the PM regeneration request is present. This also obtains advantages other than advantage (4).

The control mode of the fan 43 and the grille shutter 47 at the normal time when the ambient air amount increasing process is not executed is not limited to the control mode illustrated in the embodiment described above, and may be appropriately changed.

The driving of the fan 43 and the grille shutter 47 in the ambient air amount increasing process may be appropriately changed as long as the introducing amount of the ambient air to the engine compartment 110 can be increased. For example, in the embodiment described above, the drive duty of the fan 43 is set to the maximum value during the execution of the ambient air amount increasing process. However, a drive duty higher than the drive duty set before the starting of the ambient air amount increasing process may be set as a value other than the maximum value may be set.

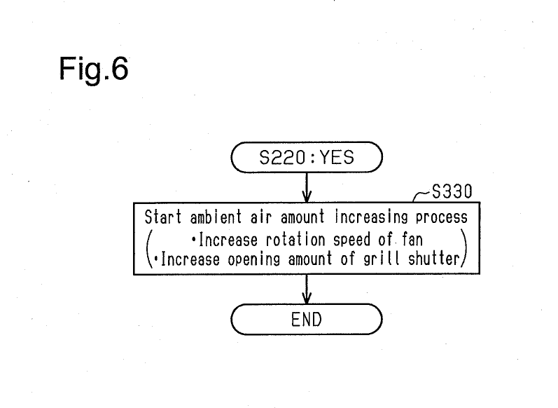

Furthermore, the process of step S330 shown in FIG. 6 may be carried out in place of the process of step S230 shown in FIG. 3 described above. That is, in the embodiment described above, the opening amount is held so that the opening amount of the grille shutter 47 becomes a maximum opening amount at the time of the execution of the ambient air amount increasing process. Instead, the opening amount of the grille shutter 47 may be increased compared to before the starting of the ambient air amount increasing process during execution of the ambient air amount increasing process. In such a case, the amount of ambient air that flows into the engine compartment 110 through the grille shutter 47 is increased compared to when the opening amount of the grille shutter 47 is not increased. Thus, the cooling effect of the ambient air drawn into the engine compartment 110 is increased.

When executing the ambient air amount increasing process, the process of holding the grille shutter 47 in the open state may be omitted. Furthermore, the vehicle 100 does not necessarily need to include the grille shutter 47.

A fan for introducing the ambient air into the engine compartment 110 may be arranged separately from the fan 43 arranged in the radiator 42. Such a fan arranged separately from the fan 43 may be driven when executing the ambient air amount increasing process.

The filter 18 may be arranged in the engine compartment 110.

The present examples and embodiments are to be considered as illustrative and not restrictive, and the invention is not to be limited to the details given herein, but may be modified within the scope and equivalence of the appended claims.

1. A controller for an engine arranged in an engine compartment of a vehicle, wherein the engine includes an exhaust gas purifying member arranged in an exhaust passage and an adjustment mechanism configured to adjust an amount of ambient air flowing into the engine compartment, the controller comprising:
a temperature raising control unit configured to execute a temperature raising process of raising temperature of the exhaust gas purifying member; and
an ambient air amount control unit configured to control driving of the adjustment mechanism,
wherein the ambient air amount control unit starts an ambient air amount increasing process that controls the adjustment mechanism so that the amount of ambient air flowing into the engine compartment is increased when the temperature raising process is being executed from that when the temperature raising process is not being executed.

2. The controller according to claim 1, wherein
the adjustment mechanism includes a fan arranged in a front part of the engine compartment and configured to blow air into the engine compartment, and
the ambient air amount increasing process includes a process for increasing a rotation speed of the fan.

3. The controller according to claim 1, wherein:
the adjustment mechanism includes
a fan arranged in a front part of the engine compartment and configured to blow air toward the engine compartment, and
a shutter arranged in front of the fan and having a variable opening amount; and
the ambient air amount increasing process includes
a process of increasing a rotation speed of the fan, and
a process of holding an opening amount of the shutter so as to be a maximum opening amount.

4. The controller according to claim 1, wherein:
the adjustment mechanism includes
a fan arranged in a front part of the engine compartment and configured to blow air toward the engine compartment, and
a shutter arranged in front of the fan and having a variable opening amount; and
the ambient air amount increasing process includes
a process of increasing a rotation speed of the fan, and
a process of increasing an opening amount of the shutter.

5. The controller of the engine according to claim 1, wherein:
the exhaust gas purifying member includes
a three-way catalyst arranged in the engine compartment, and
a filter arranged at an downstream side, with respect to a flow of exhaust gas, of the three-way catalyst to capture particles in the exhaust gas; and
the temperature raising process includes a process of regenerating the filter by raising temperature of the three-way catalyst and raising temperature of the exhaust gas flowing into the filter.

6. A method for controlling an engine arranged in an engine compartment of a vehicle, wherein the engine includes an exhaust gas purifying member arranged in an exhaust passage and an adjustment mechanism configured to adjust an amount of ambient air flowing into the engine compartment, the method comprising:
executing a temperature raising process of raising temperature of the exhaust gas purifying member;
controlling driving of the adjustment mechanism; and
starting an ambient air amount increasing process of controlling the adjustment mechanism so that the amount of ambient air flowing into the engine compartment is increased when the temperature raising process is being executed from that when the temperature raising process is not being executed.

7. A controller for an engine arranged in an engine compartment of a vehicle, wherein the engine includes an exhaust gas purifying member arranged in an exhaust passage and an adjustment mechanism configured to adjust an amount of ambient air flowing into the engine compartment, the controller comprising:
circuitry configured to
execute a temperature raising process of raising temperature of the exhaust gas purifying member,
control driving of the adjustment mechanism, and
start an ambient air amount increasing process of controlling the adjustment mechanism so that the amount of ambient air flowing into the engine compartment is increased when the temperature raising process is being executed from that when the temperature raising process is not being executed.
